(19) United States
(12) Patent Application Publication
(10) Pub. No.: US 2019/0297797 A1
(43) Pub. Date: Oct. 3, 2019

(54) IRRIGATION FLOW SENSOR SYSTEMS AND METHODS OF CONTROLLING IRRIGATION

(71) Applicant: Rain Bird Corporation, Azusa, CA (US)

(72) Inventors: Harvey J. Nickerson, El Cajon, CA (US); Steven W. Weiler, Escondido, CA (US); Chong Wang Kwak, Tucson, AZ (US); Steven D. Geerligs, Tucson, AZ (US); Anderson I. Micu, San Diego, CA (US)

(21) Appl. No.: 16/374,277

(22) Filed: Apr. 3, 2019

Related U.S. Application Data
(60) Provisional application No. 62/651,942, filed on Apr. 3, 2018.

(51) Int. Cl. A01G 25/16; G05B 19/042

(52) U.S. Cl. CPC A01G 25/165; A01G 25/02; G05B 19/042

(57) ABSTRACT

In some embodiments, systems and methods provide a water flow controlled irrigation system, comprising: an irrigation water flow sensor system comprising: a housing comprising a pipe nesting surface configured to be positioned adjacent with an irrigation pipe; an acoustic sensor secured with the housing proximate the pipe nesting surface; a sensor control circuit configured to receive acoustic data, and identify when a change in detected acoustic data is consistent with a first predefined acoustic pattern; and a flow indicator output communicatively coupled with the sensor control circuit and configured to further coupled with a separate irrigation controller that is configured to control irrigation valves of the irrigation system in accordance with an irrigation schedule, and wherein the sensor control circuit is configured to activate a first flow notification from the flow indicator output when the change in detected acoustic data is consistent with the first predefined acoustic pattern.

### CROSS-REFERENCE TO RELATED APPLICATION

This application claims the benefit of U.S. Provisional Application No. 62/651,942, filed Apr. 3, 2018, which is incorporated herein by reference in its entirety.

### TECHNICAL FIELD

This invention relates generally to controlling irrigation.

### BACKGROUND

Many types of irrigation systems enable automated irrigation of plant life. With some plant life and/or in some geographic regions irrigating can be costly. The amount of water applied to the plant life can be critical. Accordingly, some systems utilize sensor data to aid in controlling the irrigation system and/or the quantity of water applied.

### BRIEF DESCRIPTION OF THE DRAWINGS

Disclosed herein are embodiments of systems, apparatuses and methods pertaining to controlling irrigation. This description includes drawings, wherein:

FIGS. 1A-C show simplified block diagrams of exemplary water flow controlled irrigation systems, in accordance with some embodiments.

FIG. 2 shows a simplified block diagram of the exemplary irrigation system further illustrating irrigation pipes fluidly coupled with one or more water distribution devices, in accordance with some embodiments.

FIG. 3 illustrates a simplified cross-sectional view of an exemplary flow sensor system secured adjacent with an exterior pipe surface of an irrigation pipe, in accordance with some embodiments.

FIGS. 4-6 illustrate simplified cross-sectional views of exemplary flow sensor systems, in accordance with some embodiments.

FIG. 7 shows a simplified perspective view of an exemplary flow sensor system 104, similar to that of FIG. 4, positioned about an irrigation pipe, in accordance with some embodiments.

FIG. 8 illustrates a simplified exemplary graphical representation of acoustic intensity versus frequency of acoustic data detected proximate an irrigation pipe, in accordance with some embodiments.

FIG. 9 shows a graphical representation of an exemplary change in temperature measured at an irrigation pipe relative to a graphical representation of a change in temperature of an environment in which the irrigation pipe is located, in accordance with some embodiments.

FIG. 10 illustrates a simplified flow diagram of an exemplary process of controlling irrigation based on water flow, in accordance with some embodiments.

FIG. 11 illustrates a simplified flow diagram of an exemplary process of controlling irrigation based on water flow, in accordance with some embodiments.

FIG. 12 illustrates an exemplary system for use in implementing methods, techniques, devices, apparatuses, systems, servers, sources and providing control over irrigation, in accordance with some embodiments.

Elements in the figures are illustrated for simplicity and clarity and have not necessarily been drawn to scale. For example, the dimensions and/or relative positioning of some of the elements in the figures may be exaggerated relative to other elements to help to improve understanding of various embodiments of the present invention. Also, common but well-understood elements that are useful or necessary in a commercially feasible embodiment are often not depicted in order to facilitate a less obstructed view of these various embodiments of the present invention. Certain actions and/or steps may be described or depicted in a particular order of occurrence while those skilled in the art will understand that such specificity with respect to sequence is not actually required. The terms and expressions used herein have the ordinary technical meaning as is accorded to such terms and expressions by persons skilled in the technical field as set forth above except where different specific meanings have otherwise been set forth herein.

### DETAILED DESCRIPTION

Generally speaking, pursuant to various embodiments, systems, apparatuses and methods are provided herein useful to in controlling irrigation based on water flow within one or more irrigation pipes, conduits, tubes, and the like. Some embodiments provide a non-invasive water flow sensor for use in an irrigation system. The non-invasive water flow system includes a housing with a pipe nesting surface configured to be positioned adjacent to an exterior surface of an irrigation pipe that is configured to allow water to flow therethrough, one or more sensors cooperated with the housing, and a sensor control circuit. In some embodiments the sensors include an acoustic sensor coupled to the housing proximate the pipe nesting surface and configured to receive acoustic data. The sensor control circuit is communicatively coupled with the acoustic sensor and configured to receive acoustic data from the acoustic sensor. In some applications the sensor control circuit is configured to identify, based on at least the acoustic data, a pattern in the acoustic data corresponding to one or more conditions. For example, the sensor control circuit may identify one of a low water flow condition and an excessive water flow condition, with the low water flow condition corresponds to a lower than normal amount of water flow, and the excessive water flow condition corresponds to a higher than normal amount of water flow.

The sensors in some embodiments may additionally or alternatively include temperature sensors. Accordingly, in some implementations a non-invasive water flow sensor may include a pipe temperature sensor secured with the housing proximate the pipe nesting surface. An environment temperature sensor may further be secured with the housing proximate an exterior housing surface of the housing. The sensor control circuit communicatively couples with the pipe temperature sensor and the environment temperature sensor and configured to receive pipe temperature data from the pipe temperature sensor and environment temperature data from the environment temperature sensor. Based on a temperature difference between the pipe temperature data and the environment temperature data, the sensor control circuit can be configured to identify a threshold temperature difference corresponding to at least one of the low water flow condition and the excessive water flow condition.

Further, some embodiments provide a water flow controlled irrigation system that includes a non-invasive irrigation water flow sensor system comprising: a housing, a sensor control circuit, and a flow indicator output. The housing can include a pipe nesting surface that is configured to be positioned adjacent with an exterior surface of an irrigation pipe, tube, conduit or the like that is configured to transport water and allow water to flow through the irrigation system. The water flow sensor system, in some implementations, includes an acoustic sensor secured with the housing proximate the pipe nesting surface. The sensor control circuit can be communicatively coupled with the acoustic sensor and configured to receive acoustic data, and identify based on the acoustic data when a change in detected acoustic data is consistent with one or more predefined acoustic patterns. The flow indicator output communicatively couples with the sensor control circuit and is configured to further couple with an irrigation controller that is separate from the water flow sensor system. The irrigation controller is configured to control irrigation valves of the irrigation system in accordance with one or more defined irrigation schedules. The sensor control circuit is further configured to activate a flow notification from the flow indicator output based on one or more conditions. One such condition may be detected when the change in detected acoustic data is consistent with one or more of the predefined acoustic patterns.

Some embodiments additionally or alternatively utilize one or more temperature sensors. In such embodiments, an irrigation water flow sensor system includes the housing with the pipe nesting surface and at least one exterior housing surface. Again, the pipe nesting surface is configured to be positioned adjacent with an exterior surface of an irrigation pipe or the like that is configured to allow water to flow as part of an irrigation system. One or more pipe temperature sensors are secured with the housing proximate the pipe nesting surface. In some implementations, one or more environment temperature sensors are secured with the housing proximate an exterior housing surface of the housing. The sensor control circuit is communicatively coupled with the pipe temperature sensor and the environment temperature sensor, and configured to receive pipe temperature data from the pipe temperature sensor and environment temperature data from the environment temperature sensor. The sensor control circuit is further configured to detect an occurrence of a threshold temperature difference between the pipe temperature data and the environment temperature data. Again, the flow indicator output is communicatively coupled with the sensor control circuit and configured to further couple with the separate irrigation controller, which is configured to control irrigation valves of the irrigation system in accordance with the defined irrigation schedule. In some embodiments, the sensor control circuit is further configured to activate a flow notification from the flow indicator output based on the detected occurrence of the threshold temperature difference between the pipe temperature data and the environment temperature data.

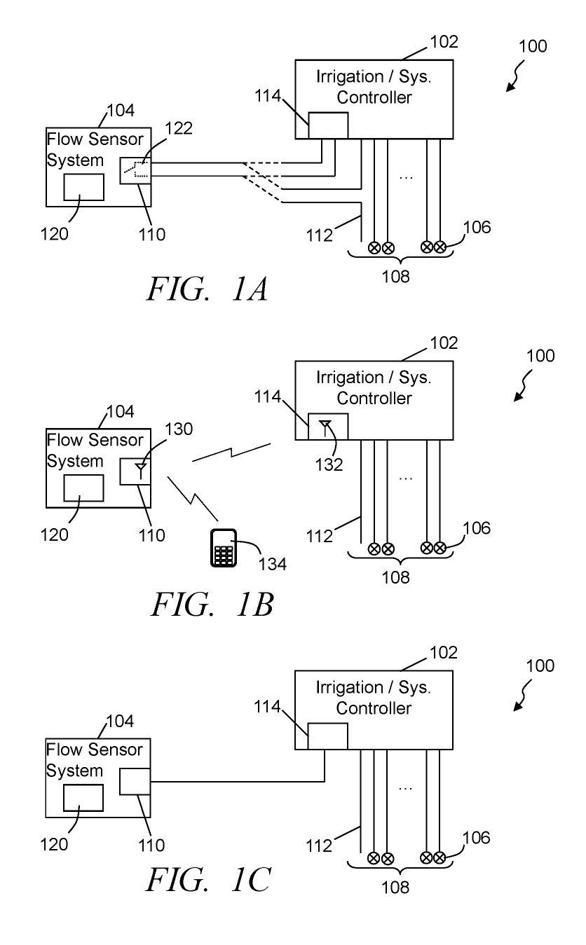

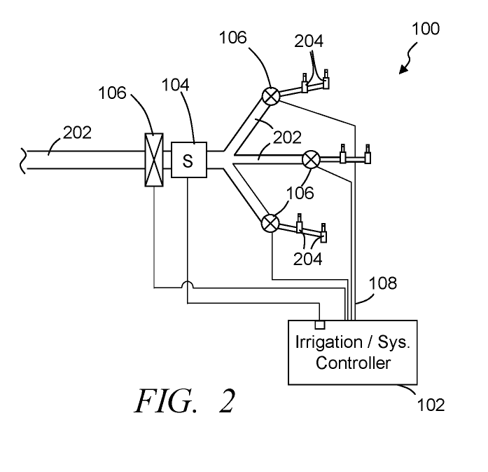

FIG. 1A shows a simplified block diagram of an exemplary water flow controlled irrigation system 100, in accordance with some embodiments. FIG. 2 shows a simplified block diagram of the exemplary irrigation system 100 further illustrating irrigation pipes 202 that are configured to carry water from a water source (not shown) to one or more water distribution devices 204 (e.g., sprinklers, drip lines, etc.), in accordance with some embodiments. Referring to FIGS. 1-2, the irrigation system is configured to enable control of irrigation based on water flow data, which in some instances may include modifying or interrupting execution of one or more watering schedules of one or more irrigation controllers 102 or other system controller according to several embodiments. The irrigation system 100 includes at least one irrigation controller 102 that couples with one or more irrigation valves 106 over controller output or activation lines 108, each coupled to a valve controller cooperated with at least one corresponding valve, which are often located in the region to be irrigated, an electrical switch to activate or deactivate lighting or other devices controlled by the irrigation controller 102. As is well known, one or more water distribution devices 204 (e.g., sprinkler devices, drip lines and/or other irrigation devices) may be coupled to each valve 106 via one or more irrigation pipes 202. The irrigation system further includes at least one water flow sensor system 104 that communicatively couples with the separate irrigation controller 102. The flow sensor system 104 includes at least one flow indicator output/input 110 configured to communicatively couple with the separate irrigation controller 102. It is noted that the above and below are described with reference to the flow sensor system 104 coupling with an irrigation controller. It will be appreciated, however, that the flow sensor system 104 can, in some embodiments, operate with other system controllers. These other system controllers 102 may house or facility management system controllers that control other systems (e.g., heating, air conditioning, fountain, gate, lighting, etc.) in addition to irrigation. Typically, the system controller operates local at the site where water flow is being monitored and/or irrigation is being controlled. In other implementations, however, the system controller may be remote from the flow sensor system. Accordingly, the flow sensor system is not limited to operate with an irrigation controller, but instead can operate with other types of control systems, including other types of non-irrigation controllers that are concerned with flow along a conduit, pipe, duct, or the like.

In some implementations, the flow sensor system 104 provides a hardwire coupling with the irrigation controller 102. Additionally or alternatively, the flow sensor system includes one or more wireless transmitters and/or transceivers that at least wirelessly transmit data to the irrigation controller. For example, the flow indicator output 110 may be coupled with and/or be in communication with the irrigation controller 102 in different ways, which may depend on the irrigation controller and/or the capabilities of the irrigation controller. In some applications, the flow indicator output 110 includes one or more transmitters and/or transceivers configured to wired and/or wirelessly communicate with the irrigation controller 102, a user's separate smartphone, tablet, etc., and/or other devices via wired and/or wireless communication and/or computer networks. In some embodiments, the flow sensor system 104 may be connected from the flow indicator output 110 direct to an irrigation controller interface 114 (e.g., a rain sensor input, flow sensor input, etc.) of the irrigation controller 102. The flow sensor system 104, in some embodiments, determines an indication that a relationship exists between a threshold or other criteria (e.g., temperature change or difference threshold, acoustic threshold, correlation with a predefined acoustic pattern, etc.) and measurement data (e.g., acoustic data, temperature data, etc.), and in the event that a threshold relationship is identified, the flow indicator output can be activated.

In some embodiments, the flow indicator output 110 couples in series with the common line 112 of the activation lines 108. For example, the common line 112 electrically passes through the flow sensor system 104 (e.g., a common line switch 122 or other switching device couple with the common line). When the flow sensor system determines or receives an indication that a threshold condition exists (e.g., temperature difference, acoustic pattern detected, etc.) and/or that other criteria have been met, the sensor control circuit can be configured to open the common line switch 122 to activate the flow notification and interrupt the irrigation schedule being implemented by the irrigation controller (e.g., temporarily breaking the common line 112). This effectively disables the electrical signals via the activation lines 108 to the valves 106, until the common line switch 122 is closed. In this way, the irrigation controller 102 may not even be aware that the watering has been interrupted or overridden. In some embodiments, the flow sensor system 104 maintains the interruption for an interrupt threshold duration, which may be predefined (e.g., by a manufacturer), set by the user prior to or during installation, communicated by the irrigation controller, wirelessly communicated to the flow sensor system and/or irrigation controller, or the like. This allows subsequent irrigation to continue for one or more other zones, and/or to allow irrigation to resume following the correction of the flow problem without accessing the flow sensor system. In other implementations the irrigation controller may communicate a reset command, a user may access a reset option through an interface of the flow sensor system when such an interface is included in the flow sensor system, a user may initiate a reset through wireless communication (e.g., through the user's smartphone, tablet, etc.), or the like. Similarly, in some embodiments, the flow indicator output 110 includes one or more wired and/or wireless transmitters and/or transceivers controlled by a sensor control circuit and configured to communicate data, alarms, activation signals, shut-down signals, other such communications, or a combination of two or more of such communications to the irrigation controller 102.

In some applications, the activation of the flow indicator output may include activating a switch within the flow sensor system opening a circuit that can be detected by the irrigation controller or activating a switch of the flow sensor system completing a circuit causing a current to flow through the output lines to the irrigation controller interface 114. The irrigation controller 102 is configured to sense this change of state or current, and in response, the irrigation controller 102 takes one or more actions, such as temporarily halting the execution of one or more watering schedules and/or determines other appropriate actions. In some embodiments, for example, the flow indicator output 110 comprises a switch configured to couple with a sensor input of the separate irrigation controller 102. The sensor control circuit 120 is configured to cause a change in state of the switch to activate the flow notification to be detected by the irrigation controller and be utilized by the irrigation controller in interrupting the irrigation schedule being implemented by the irrigation controller. In other implementations, the flow sensor system 104 may cause one or more pulses to be detected by the irrigation controller allowing additional data to be interpreted by the irrigation controller. The current flowing can be switched off after a period of time (e.g., after a predefined period of time, in response to instructions or reset from the controller, in response to a data transmission, or a reply to a subsequent data request (e.g., when the precipitation data has returned to below the threshold level and/or the relationship between the threshold level and other criteria and the measured data no longer exists), or the like). In some applications, for example, the irrigation controller may sense the absence of the current at the irrigation controller interface 114 and resume normal execution of watering schedules.

In other embodiments, the activation of a flow notification from the flow indicator output 110 can be a data signal that includes a notification or message providing information to the irrigation controller and/or instructions instructing the irrigation controller 102. The irrigation controller may take one or more actions, such as temporarily halting execution of one or more watering schedules until a subsequent resume data signal is sent. In still other embodiments, the flow notification may additionally or alternatively be communicated to an AMR-based water meter or a cellular based water meter at the property where irrigation is controlled. Additionally or alternatively, in some implementations, the irrigation controller 102 can communicate a notification to a water utility source supplying the water to the property that irrigation has been interrupted.

As described above and further below, in some embodiments the flow sensor system 104 may wireless communication with the irrigation controller 102. For example, the flow sensor system 104 may include one or more wireless transceivers that wirelessly communicate with one or more wireless transceivers of the irrigation controller. FIG. 1B shows a simplified block diagram of an exemplary water flow controlled irrigation system 100 with the flow sensor system 104 in wireless communication with the irrigation controller 102, in accordance with some embodiments. In some implementations, the flow indicator output 110 may include one or more wireless transmitter or transceiver 130 that is configured to wireless communicate with one or more transceivers 132 of the irrigation controller. In other embodiments, as described above and further below, the flow sensor system 104 is directly coupled with a sensor input of the irrigation controller 102. Further, in some implementations, the flow sensor system 104 may wirelessly communicate with a user device 134 (e.g., smart phone, tablet, laptop, computer, etc.). FIG. 1C shows a simplified block diagram of an exemplary water flow controlled irrigation system 100 with a flow sensor system 104 directly coupled with the irrigation controller 102, in accordance with some embodiments. In some implementations, for example, the irrigation controller interface 114 comprises a sensor input, which may be a rain sensor input, a flow sensor input, and/or other such sensor input. The flow indicator output 110 may communicate one or more flow notifications to the sensor input of the irrigation controller interface.

Different embodiments of the flow sensor systems 104 can be configured to operate with one or more types of irrigation controllers and/or to couple with irrigation controllers in multiple different ways. In some implementations, the flow sensor system can couple across a common line 112 from the irrigation controller 102 and can open the common line to interrupt irrigation. In some implementations, the irrigation controller 102 may be unaware that irrigation has been interrupted. A notification may be issued by the flow sensor system 104 (e.g., an visual indicator, an audio output that can be heard by someone within a threshold distance, a wireless communication to remote device (e.g., a user's smart phone, laptop, a remote server, etc.), communication to the irrigation controller, or the like). In other implementations, the flow sensor system 104 is configured to couple with a sensor input of an irrigation controllers 102. With some irrigation controllers, the sensor input trips a switch to open a common line. The irrigation controller typically would be unaware of the reason for the interruption, and simply register the activation of the switch. In still other embodiments, the flow sensor system is configured to couple with an irrigation controller 102 configured to couple with and receive flow sensor input from a flow sensor (e.g., series of pulses corresponding to a detected flow rates, pulses that are increased or decreased in frequency corresponding to a rate at which a wheel or paddle rotates, etc.). The irrigation controller configured to receive flow sensor inputs typically is configured to evaluate the flow rates to determine whether the flow is within expected threshold ranges or exceeding one or more expected ranges. The flow sensor system 104 can be configured to communicate pulses or other such indications to effectively mimic other types of invasive flow sensors to provide pulses or other such indications that the irrigation controller is expecting (e.g., pulses corresponding to a flow within expected or normal range (e.g., 1 gpm), or pulses far in excess of a threshold (e.g., 100 gpm). In some embodiments, flow sensor systems 104 are configured to communicate information and/or sensor data to a “smart” irrigation controller 102 that is configured to cooperatively operate with the specific type of flow sensor system 104. The irrigation controller can be configured to receive this information and/or data, evaluation and/or process the data and/or information, and make one or more determinations regarding adjustments relative to one or more zones, interruption of irrigation, interruption of one or more zones, communication with the user, communication with a central irrigation control system, and/or other such actions.

The flow sensor system 104 is separate from the irrigation controller 102 and in a position to detect the flow of water through one or more irrigation pipes 202. Further, the flow sensor system 104 is positioned external to a corresponding irrigation pipe and detects relevant data through techniques that are non-invasive to the irrigation pipes. Some previous flow sensors included paddles or other mechanical systems that are positioned in the water flow within interior to the irrigation pipes. Thus, such previous systems typically required a pipe to be cut and the flow sensor positioned within the water flow path and exposed to the water flowing through the pipes. These systems are often costly, costly to install, add complexity to the installation, and often rapidly degrade due to the direct contact with the water flow within the irrigation pipe.

Alternatively, the flow sensor system 104 can be positioned relative to an irrigation pipe 202 without having to cut into the irrigation pipe or having a portion of the sensor positioned within the water flow through the interior of the irrigation pipe. For example, the flow sensor system 104 may be secured adjacent with and buried with an irrigation pipe 202, and in many instances abutting the irrigation pipe; secured with an exterior of an irrigation pipe 202 above ground (e.g., proximate an above ground valve), or the like. In some embodiments the flow sensor system 104 obtains measurements representative of water flow within the corresponding irrigation pipe 202 without interfering with the flow of water through the irrigation pipe or having a portion of the sensor system positioned with the irrigation pipe. The detected data and/or measurements may include one or more of temperature data, temperature differences, acoustic or sound data, and/or other relevant information.

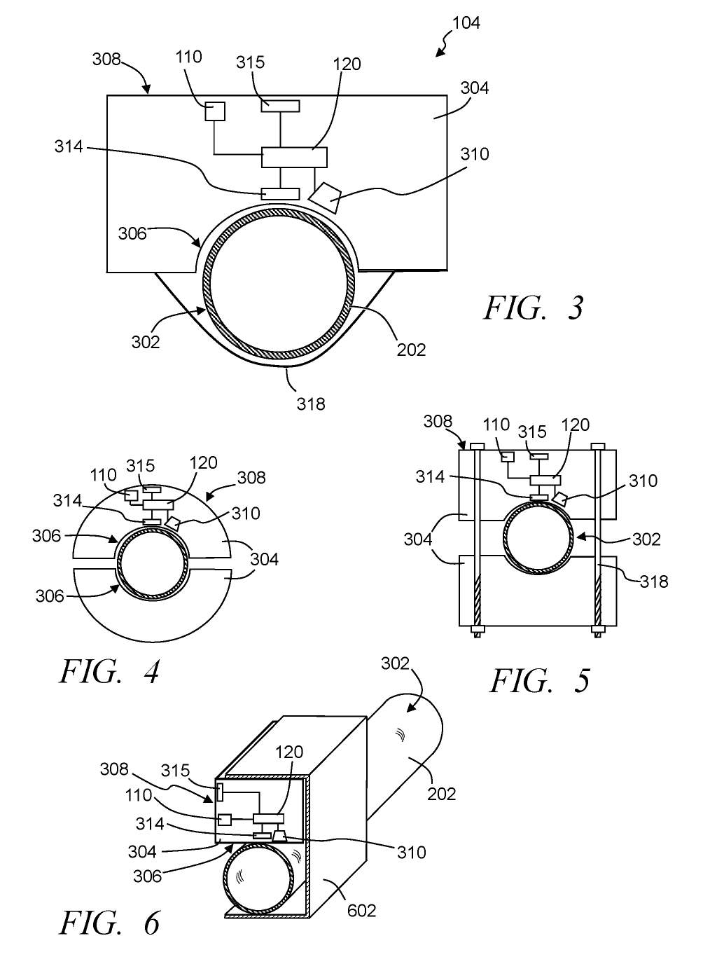

FIG. 3 illustrates a simplified cross-sectional view of an exemplary non-invasive flow sensor system 104 secured adjacent with an exterior pipe surface 302 of an irrigation pipe 202, in accordance with some embodiments. FIGS. 4-6 illustrate simplified cross-sectional views of exemplary flow sensor systems 104, in accordance with some embodiments. Referring to FIGS. 1-6, the flow sensor system 104 includes a casing or housing 304 that includes one or more pipe or pipe nesting surfaces 306, and typically includes at least one exterior housing surfaces 308. In some embodiments, the pipe nesting surface 306 is configured to be positioned adjacent with an exterior surface 302 of an irrigation pipe 202. Again the irrigation pipes are configured to allow water to flow through the irrigation system 100, with the flow sensor system cooperated with the pipe through non-invasive techniques. The housing 304 can be constructed of substantially any relevant material, and typically is constructed of material to withstand outside weather conditions, and in some instances is configured to be buried in the soil. For example, the housing may be formed from plastic, PVC, silicon, brass, aluminum, other such materials, or combination of two or more of such materials. In some implementations, the housing 304 may be formed from one or more pieces of plastic and/or PVC formed through injection molding. Further, the housing may include one or more sub-housings that cooperate to form the housing, and/or may cooperate with separate structures or housings, which may help in cooperating and/or positioning the flow sensor system 104 with the exterior of the irrigation pipe 202. Some embodiments may be constructed with a “clam-shell” configuration, which may include one or more hinges along one side allowing the housing to open to be fitted about the irrigation pipe 202. One or more securing or locking mechanism may be cooperated with the housing (e.g., snap fit, tongue and groove, latch, lock, pin, etc.) and/or external mechanisms can be used to secure the housing (e.g., twist-ties, cable or zip-ties, rivet, hitch pin, lynchpin, cotter pin, clevis pin, etc.).

In some applications the pipe nesting surface 306 is shaped to enhance a cooperation with the irrigation pipe 202, such as including one or more grooves, recesses, extensions, ridges, pegs, or the like that cooperate with the irrigation pipe. For example, in some embodiments, the housing includes a semicircular groove defining at least part of the pipe nesting surface 306 that is configured to mate with the exterior pipe surface of the irrigation pipe. In other implementations, one or more grooves having less than a semicircular cross-section may be utilized. Still other implementations do not include a groove. Similarly, some embodiments include one or more protrusions, ridges, beams, or the like that aid in at least aligning and in some instances maintaining a position of the flow sensor system 104 with the irrigation pipe. The flow sensor system may be secured with the irrigation pipe through one or more securing mechanisms 318 or method, such as clamping or latching mechanism of the housing, snap-fit, other structures of the housing, one or more zip-ties, clamps, wires, friction fits, Velcro™ straps, screws, bolts and nuts, hose-clamps, U-Bolt and nuts, other such securing mechanisms, or a combination of two or more of such mechanisms. In some instances, the one or more securing mechanisms are positioned along at least a portion an exterior of the housing 304.

Referring to FIG. 6, some embodiments include a clamp and/or casing 602 that is positioned about some or all of the flow sensor system 104. In some implementations, the casing 602 may further encase some or all of the irrigation pipe adjacent the flow sensor system. Still further, in some instances, the casing 602 provides added protection for the flow sensor system, and may be formed from metal, plastic, PVC, other such material or combination of materials.

FIG. 7 shows a simplified perspective view of an exemplary flow sensor system 104, similar to that of FIG. 4, positioned about an irrigation pipe 202, in accordance with some embodiments. In this embodiments, the housing 304 comprises first and second sub-housings 304a-b that each include a pipe groove forming at least a portion of the pipe nesting surfaces 306 to allow the housing to enclose or sandwich at least a portion of the irrigation pipe 202. In some implementations, the housing may include one or more securing grooves 702, channels or the like configured to position and/or maintain a position of one or more zip-ties, bands, straps, cables, or other mechanisms of securing the sub-housings together and/or securing the flow sensor system 104 with the exterior of the irrigation pipe 202.

Referring to FIGS. 1-7, the flow sensor system 104 includes one or more sensors, detectors or other devices configured to detect or register one or more conditions that are used in determining whether water is flowing within the pipe 202, flowing in excess of one or more thresholds, or other such flow conditions. For example, in some embodiments, the flow sensor system 104 includes one or more acoustic sensors 310 secured with the housing 304. Typically, at least one acoustic sensor 310 is secured with and/or within the housing to be positioned proximate the pipe nesting surface 306. Accordingly, when the flow sensor system is positioned adjacent the irrigation pipe the acoustic sensor 310 is positioned proximate to and in some instances abutting with the exterior pipe surface 302 of the irrigation pipe 202. The acoustic sensor is configured to detect sound at least within the irrigation pipe 202, including sounds caused by water flowing in the irrigation pipe, lack of sound, lack of changes in sound, and/or other such acoustic data. The acoustic sensor 310, in some implementations, includes one more microphones, surface acoustic wave sensors, hydrophones, vibration sensors, other such sound/audio sensors, or combination of two or more of such sensors, and which may include one or more filters, other limited systems, bandpass filtered, and/or other such signal processing. In some embodiments, the sensor control circuit 120 and/or separate processing system within the flow sensor system 104 performs some or all of the signal processing.

Some embodiments additionally or alternatively include one or more other types of sensors. For example, in some embodiments, the flow sensor system includes one or more temperature sensors 314 and 315 in addition to or alternatively to one or more acoustic sensors. A pipe temperature sensor 314 may be secured with or within the housing 304 and positioned proximate to the pipe nesting surface 306 and configured to sense temperature measurements corresponding to a temperature of or within the irrigation pipe 202. Some embodiments additionally include one or more environment temperature sensors 315 secured with or within the housing 304 proximate at least one of the exterior housing surfaces 308 of the housing 304. The environment temperature sensor 315 is configured to sense temperature measurements corresponding to temperatures of an environment in which the flow sensor system 104 is positioned. For example, the environment temperature sensor 315 may be configured to detect the temperature of the soil surrounding the flow sensor system 104 when the flow sensor system is secured with an irrigation pipe that is buried in the ground. Similarly, the environment temperature sensor 315 may detect the air temperature when the flow sensor system 104 is secured with an irrigation pipe that is above ground and exposed to the air. In some implementations, one or more passages (e.g., curves, u-bends, etc.), screens and/or other such structures are formed in and/or cooperated with the housing to protect the acoustic sensor, pipe temperature sensor, environment temperature sensors, and/or other such sensors, while enabling the sensors to detect the relevant conditions. Some embodiments may further include one or more additional remote environment temperature sensors that are configured to detect the temperature of an environment remote from the flow sensor system 104. This remote environment temperature data may be compared to the environment temperature proximate the flow sensor system, and/or the environment temperature proximate the flow sensor system may be mathematically cooperated with the remote environment temperature data to provide a nominal environmental temperature and/or an average environment temperature, which may take into account variations in environment temperature proximate the flow sensor system. One or more tables may be stored in the flow sensor system for use in evaluating the environmental temperature data, the remote temperature data, and/or some combination thereof. In some instances, for example, the table defines relevant temperature variations over time (e.g., yearly) relative to general locations (e.g., cites, counties, zip codes, regions, etc.).

For example, the flow sensor system may include the environment temperature sensor 315 within the housing and proximate the external environment, and another remote environment temperature sensor (e.g., configured to be positioned at or proximate the soil surface), such as a surface temperature probe. The flow sensor system 104 and/or irrigation controller 102 can be configured to calculate a nominal soil temperature and utilize this for a nominal soil temperature that can be then referenced by the flow sensor system in determining whether a temperature difference or between the pipe and the nominal soil temperature exists, which can be used to determine whether there is water flowing and/or a rate of water flow. Some embodiments maintain a look-up table organized by region, county, city, zip code, etc. for average soil types of the area to get a correct thermal diffusivity.

In some embodiments, the flow sensor system 104 further includes one or more sensor control circuits 120 communicatively coupled with the one or more sensors of the flow sensor system. For example, the sensor control circuit 120 is communicatively coupled with the acoustic sensor 310 and configured to receive acoustic data, and/or is communicatively coupled with the one or more temperature sensors 314, 315 and configured to receive temperature data (e.g., pipe temperature data from the pipe temperature sensor and environment temperature data from the environment temperature sensor). The sensor control circuit 120 can be implemented through one or more microprocessors having internal non-transitory memory and/or coupled with external non-transitory memory configured to store code implemented by the one or more microprocessors.

In some embodiments, the sensor control circuit 120 may cause some or all of the sensor data or information based on the sensor data to be communicated through the flow indicator output 110 to the irrigation controller 102 to initiate one or more actions by the irrigation controller and/or to be utilized by the irrigation controller in determining whether one or more actions are to be initiated. Additionally or alternatively, the sensor control circuit 120 can utilize the sensor data to make one or more determinations. In some embodiments, the sensor control circuit receives acoustic data from the one or more acoustic sensors 310, and identifies based on the acoustic data when a change in detected acoustic data is consistent within corresponding thresholds of one or more predefined acoustic patterns. The one or more acoustic patterns may be provided to the sensor control circuit (e.g., stored during manufacturing, stored during a set-up, etc.) and/or determined by the sensor control circuit (e.g., through a learn procedure, learned over time, etc.). In some embodiments, for example, the sensor control circuit 120 identifies, based on the acoustic data, a pattern in the acoustic data corresponding to one or more of a low water flow condition and an excessive water flow condition, wherein the low water flow condition corresponds to a lower than normal amount of water flow, and wherein the excessive water flow condition corresponds to a higher than normal amount of water flow.

Additionally or alternatively, the sensor control circuit 120 can implement code that causes the sensor control circuit to evaluate temperature data, and in some implementations to activate a flow notification from the flow indicator output 110 based on a detected threshold temperature change or temperature difference occurring such as between a pipe temperature and a temperature of an environment in which the pipe is located (e.g., soil temperature, air temperature, surrounding water temperature, etc.).

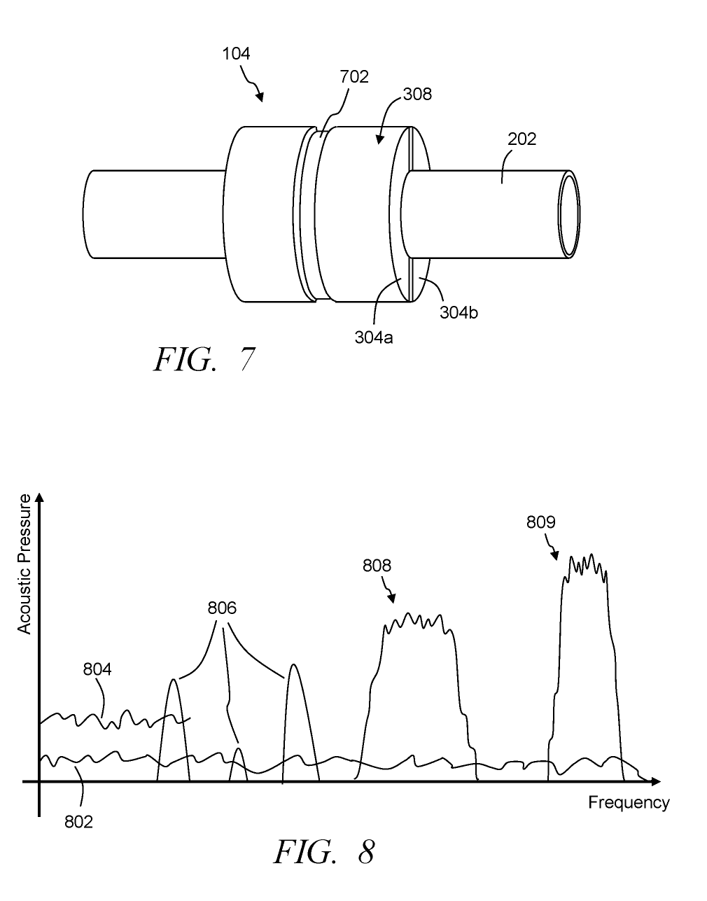

FIG. 8 illustrates a simplified exemplary graphical representation of sound or acoustic pressure versus frequency of acoustic data detected proximate an irrigation pipe, in accordance with some embodiments. Various different sound signatures may be detected, such as noises from automobiles and other such traffic 802, background noises 804 (e.g., gardening equipment, people conversing, people walking, toilet flushes, etc.), bubble and/or “burping” sounds 806 within an irrigation pipe, water flowing sounds 808-809 within the irrigation pipe, and other such sounds. Predefined acoustic patterns can be used that correspond to known water flow sounds 806, 808-809, other known sounds may be determined that correspond to different aspects of water flow within the irrigation pipes, irrigation events (e.g., activation, shut-off, pressure lease, etc.), and the conditions of the irrigation pipes and system. These predefined acoustic patterns can be used in evaluating the acoustic data obtained by the one or more acoustic sensors 310 to determine one or more conditions and/or aspects of the irrigation system. For example, acoustic patterns may be used to determine whether or not water is flowing, whether there is excess water flowing, whether there is a leak based on continued water flow, whether there is a leak based on continued water flow when water flow is not expected, and/or other such conditions.

In some embodiments, the sensor control circuit receives acoustic data from one or more acoustic sensors 310, may forward the acoustic data to the irrigation controller, may perform some processing of the acoustic data, and/or may evaluate the acoustic data. For example, the sensor control circuit can evaluate the acoustic data relative to one or more predefined acoustic patterns, one or more thresholds, and/or other such evaluations. Further, in some applications, the sensor control circuit 120 and/or the irrigation controller 102 is configured to identify based on the acoustic data when a change in the detected acoustic data is consistent with one or more of the predefined acoustic patterns (e.g., predefined acoustic patterns 806, 808-809). Based on the evaluation the sensor control circuit and/or irrigation controller can cause one or more actions to be implemented. In some embodiments, for example, the sensor control circuit is configured to activate one or more flow notifications from the flow indicator output 110 when the change in detected acoustic data is consistent with one or more predefined acoustic patterns. The notification can be an activation of a switch within the flow sensor system 104 (e.g., common line switch 122), the communication of an instruction to an irrigation controller, the communication of sensor data to the irrigation controller, other such notifications, or a combination of such actions. Some embodiments compare the change in the acoustic data with a set of multiple predefined acoustic patterns, and determine an estimate flow rate of the water within the irrigation pipe based on the change in acoustic data being consistent with one of the predefined acoustic patterns of the set of the multiple predefined acoustic patterns. In other implementations, the change in acoustic data may be evaluated relative to a stabilized number (e.g., an average maximum and/or minimum volume, frequency or the like) or average sampling of predefined acoustic patterns.

As introduced above, the sensor control circuit 120 in some instances may perform processing of the acoustic data. Such processing may include applying one or more filters to the acoustic data to exclude some sounds and/or acoustic information. For example filtering based on frequency may eliminate some extraneous noises (e.g., traffic 802, background noises 804, and the like). Similarly, the processing may include detecting one or more sequences of multiple acoustic patterns. In some instances, the detection of the sequence of patterns can allow the sensor control circuit (or the irrigation controller) to determine one or more states of operation of the irrigation system. For example, often upon activation of an irrigation valve 106, air is forced from the irrigation pipes causing noise from the air rushing through the pipes and out of the sprinklers, drip lines, etc., bubbling, burping and/or other noises may be detected along with or after the air rushing, followed by the detection of a flow of water through the irrigation pipe. Similarly, in some instances a humming from the activation of the valve may be detected. Such a sequence of acoustic patterns indicates a start of irrigation relative to the pipe being monitored. The sensor control circuit 120 may be configured to discard or filter out acoustic data during such irrigation initiation, and/or filter out audio data a threshold period of time after the detection of the irrigation initiation sequence to acquire acoustic data corresponding to the flow of fluid during irrigation, which can be evaluated relative to one or more other acoustic patterns. As another example, a detected pattern of a decrease in frequency and/or intensity within a threshold variation of a predefined rate may correspond to an attempted shutting off of flow through that pipe by the irrigation controller (e.g., a termination of irrigation runtime for a particular zone). This indication can be used to continue to evaluate acoustic data a threshold period of time after the detected shutdown to confirm flow no longer continues. Still other processing can include comparing the acoustic data to one or more predefined acoustic patterns, evaluating data relative to thresholds, and/or other such processing. Some processing may be duplicated by the irrigation controller 102, while some processing is off-loaded to the irrigation controller.

The duration of the sensed data can vary depending on one or more factors. Typically, the duration needed to detect acoustic data is relatively short. For example, for some types of sounds the duration can be less than two seconds, often less than one second to capture sufficient information to be compared to one or more predefined sound patterns. Often, however, the acoustic data is captured for periods of time greater than such limited time to provide extended capture of such acoustic data as a confirmation of the sound captured or to ensure consistent sound is detected. Some embodiments may take samples from an extended capture duration (e.g., take several different 0.5 second samples separated in time from a 30 second capture duration). Similarly, repeated captures may be used to determine whether there are variations over time. Further, some embodiments continue to capture data in an attempt to capture information that may occur only infrequently (e.g., that are triggered upon a sufficient build-up of pressure, such as a crack in a pipe that when sufficient pressure builds up opens to release some pressure and then closes again until the sufficient pressure builds up again). Such occurrences may be detected based on predefined sound patterns, which may be learned over time and/or provided to the flow sensor system 104 and/or the irrigation controller 102.

As introduced above, in some embodiments, the flow sensor system 104 may additionally or alternatively include one or more temperature sensors 314-315. The sensor control circuit 120 can communicatively couple with the one or more temperature sensors 314-315, and is configured to receive temperature data (e.g., pipe temperature data from the pipe temperature sensor 314 and environment temperature data from the environment temperature sensor 315) from the temperature sensors 314-315. Further, the sensor control circuit 120 in some embodiments detects when a threshold temperature difference or change between the pipe temperature data and the environment temperature data occurs. In some applications, the threshold temperature difference is evaluated relative to one or more threshold periods of time and/or limited to occurring within a corresponding one of one or more threshold periods of time.

The temperature within the irrigation pipe over time during a lack of water flow is expected to reach an equilibrium temperature corresponding to a temperature of the environment in which the irrigation pipe is located. For example, the temperature within an irrigation pipe will, over time while water has not been allowed to flow through the pipe for a threshold period of time, typically become equal to or substantially equal to the temperature of soil surrounding the irrigation pipe when the irrigation pipe is buried within the soil. Similarly, the temperature of the water in the pipe typically will track changes in temperature of the soil over time when the water is not flowing. For example, the temperature of the water may increase as the temperature of the soil increases during the day and decrease as the temperature of the soil decreases in the evening and night. Water that is allowed to flow through irrigation pipes typically has a temperature that is different than the temperature of the environment in which the pipe is located (e.g., buried in the soil) because the temperature of the source of water is different than the environment where temperature is measured. Accordingly, in response to an opening of a valve and allowing water to flow through the irrigation pipe, the temperature of the exterior of the pipe typically experiences a relatively rapid change in temperature in response to the water flowing through the irrigation pipe.

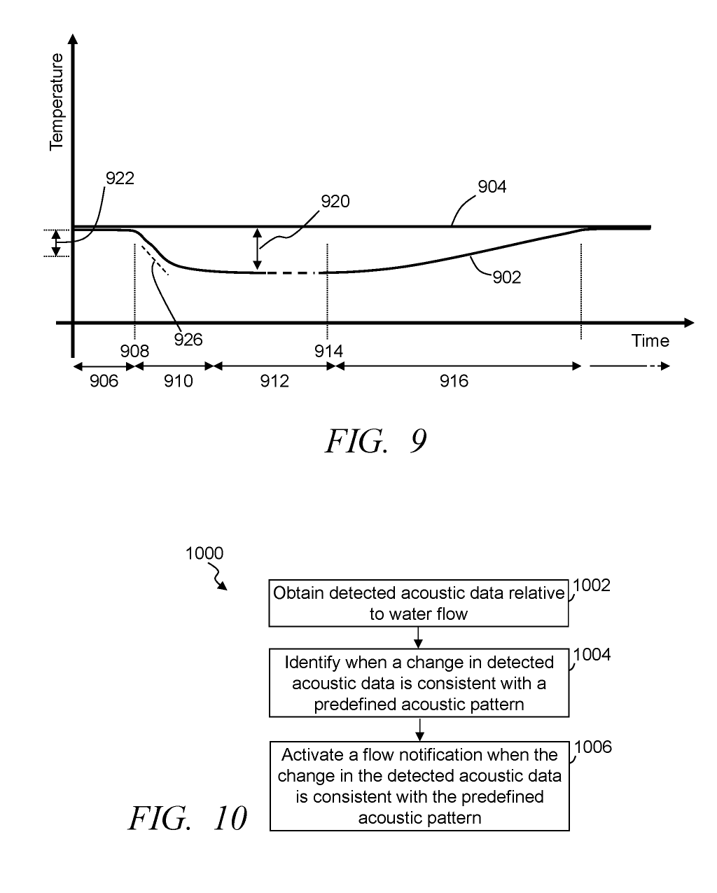

FIG. 9 shows a graphical representation of an exemplary change in temperature 902 measured at an irrigation pipe (over time in response to an activation of a flow of water through the irrigation pipe 202) relative to a graphical representation of temperature 904 of an environment in which the irrigation pipe is located during that period of time, in accordance with some embodiments. As show, the temperature of the pipe 902 prior to activation of irrigation (e.g., a pre-flow duration 906) is the same or substantially the same as the temperature of the environment 904. Again, the temperature of the pipe prior to activating the flow of water through the pipe over time typically (given sufficient time between water flows) becomes equal to or substantially equal to the temperature of the surroundings. In response to the flowing of water at an activation time 908, the temperature of the pipe begins to change consistent with the temperature of the water flowing through the pipes (e.g., the temperature drops when the temperature of the water is less than the soil in which the pipe is buried). The temperature of the pipe continues to change (e.g., in this example continues to drop) over a temperature change period of time 910 as the temperature of the pipe reaches an equilibrium, which is dependent on the temperature of the water and typically becomes equal to or substantially equal to the temperature of the water. The temperature of the pipe remains at this temperature during a differences period of time 912, which includes a reminder of the duration the water is flowing and typically for a period of time after the flow is halted at a stop flow time 914. Following stop flow time 914, the temperature 902 of the pipe gradually begins to return to the temperature of the surrounding environment 904 over a temperature return period of time 916. The temperature return period of time 916 is dependent on many factors including, for example, whether water stays in the pipe, how long water stays in the pipe, the material of the pipe, the temperature difference 920 between the temperature of the environment 904 and the temperature of the water (i.e., substantially the same as the temperature of the pipe during the difference period of time), and other such factors. Typically, it is expected the temperature return period of time 916 is several times longer than the temperature change period of time 910. The temperature of the environment 904 remains relatively constant over a given period of time, or changes slow relative to at least the temperature change period of time 910 (e.g., air and soil may increase during daylight hours and drop during nighttime hours, and the temperatures of irrigation pipes would typically follow the changes in temperature of the soil, with the exception of when water is allows to flow).

In some embodiments, the sensor control circuit 120 and/or the irrigation controller 102 receive the pipe temperature data from the pipe temperature sensor 314 and environment temperature data from the environment temperature sensor 115, and can be configured to evaluate these temperatures and/or the differences between these temperatures. In some instances, the sensor control circuit and/or the irrigation controller is configured to detect an occurrence of a threshold temperature difference 922 or change between the pipe temperature data and the environment temperature data. Further, in some applications the change or difference in temperature is detected relative to one or more time thresholds, and the detected threshold temperature difference is limited to occurring within a threshold period of time.

Additionally, in some embodiments, the evaluation of the change or difference in temperature data further determines a rate of change 926 and/or a slope of the portion of the curve on the graph representing the change in temperature of the irrigation pipe over time. One or more predefine rates of change and/or slopes may define threshold levels of flow within the irrigation pipe. This predefined rate may be defined by an outside source and provided to the flow sensor system 104 and/or the irrigation controller 102, while in other instances, the predefined rates of change and/or slopes may be learned through one or more learning processes where temperature data is acquired during known states of the irrigation process and transitions between states (e.g., off, turning on, on, turning off, high flow, low flow, etc.). In some embodiments, the sensor control circuit 120 and/or the irrigation controller 102 identify a flow rate of the water within the irrigation pipe based on the determined rate of change of temperatures and/or the relationship relative to predefined rates of change of temperature. Further, the sensor control circuit and/or irrigation controller may be configured to identify a flow of less than a nominal threshold based on the difference in temperatures between the pipe temperature data and the environment temperature data after returning to within a temperature threshold difference. For example, following the termination of irrigation the temperature difference between the pipe temperature and the surrounding environment gradually decreases as the temperature of the pipe approaches the temperature of the environment. Accordingly, a lack of flow or no flow can be identified when the temperature of the pipe returns to within a minimal temperature difference from the environment. Similarly, a slow flow may be identified based on a failure of the temperature difference to return with a threshold after a threshold period of time. In some applications, the flow sensor system 104 may include one or more heating and/or cooling elements that when activated are configured to locally modify the temperature of the irrigation pipe 202 and/or water within the pipe. Such a heating/cooling element can be positioned proximate to or upstream (up-flow) of the pipe temperature sensor 314. As such, when water does begin to flow the change in temperature has a greater rate of change and/or is more quickly detected.

In some embodiments, the sensor control circuit causes one or more actions to be implemented and/or makes one or more determinations based at least in part on the temperature data and/or changes in temperature over time. Again, the flow indicator output 110 can be communicatively coupled with the sensor control circuit 120, which can be configured to activate a flow notification from the flow indicator output 110 when the change in detected acoustic data is consistent with one or more predefined acoustic patterns. In some implementations, for example, the flow indicator output includes a common line switch 122 configured to couple with the common line 112 of the irrigation controller, and the sensor control circuit 120 can be configured to open the common line switch to activate the flow notification and interrupt the irrigation schedule being implemented by the irrigation controller. In other implementations, the flow indicator output comprises a wireless transceiver configured to wirelessly communicate one or more flow notifications to the irrigation controller 102.

Some embodiments alternatively or additionally communicate sensor data, information and/or instructions to the separate irrigation controller 102, which can be configured to evaluate sensor data, take one or more actions and/or make one or more determinations based on the information, data and/or instructions. The information, data and/or instructions may be communicated in response to one or more thresholds being exceeded, based on communication capabilities established, based on capabilities of the irrigation controller and/or other such factors. In some instances, the flow sensor system communicates information that may represents different estimated rates of flow and/or be used to estimate rates of flow. The sensor control circuit 120, in some embodiments, in activating the flow notification can be configured to output one or more different output values based on an estimated flow rate. For example, one output value may be representative of an excessive water flow condition corresponding to a higher than normal amount of water flow, a different output value may be representative of a low water flow condition corresponding to a lower than normal amount of water flow, and/or other output values may indicate other estimated flow rates. The estimate flow rate may be determined as a function of a determined relationship between one or more detected acoustic patterns with one or more predefined acoustic patterns, determined relationship between detected temperature differences and one or more temperature difference threshold, or other such methods.

Further, the flow sensor system 104 may communicate flow notifications to the irrigation controller that mimic some paddle flow sensors that output pulse signals indicative of a flow being detected by the rotation of the paddles within the fluid flow. Through such embodiments the sensor control circuit 120 in activating the flow notification causes a pattern of pulses to be communicated to the irrigation controller indicative of flow corresponding to one or more predefined patterns and/or the estimated flow rate. The irrigation controller 102 is configured to interpret these pattern of pulses as corresponding to an estimated flow rate.

In some implementations, however, the pulses are generated not as an estimate of an actual flow rate, but instead are generated to convey a predefined state of flow to the irrigation controller. For example, the flow sensor system 104 may be configured to identify when a flow is active based on acoustic data corresponding to a first predefined sound pattern and/or a rate of change of temperature being within a first rate change, and generate pulses at a first rate that is consistent to the irrigation controller with an expected rate or within a first pulse threshold corresponding to a normal or expected flow condition; and to identify when an excessive flow rate is occurring based on acoustic data corresponding to a second predefined sound pattern (e.g., higher pitch and/or increased volume) and/or a rate of change of temperature exceeding a temperature rate change threshold and generate pulses at a second rate that indicates to the irrigation controller an excess flow condition. In continuing this example, the first pulse rate may correspond to generically 1 gallon-per-minute (gpm) that is well below a threshold interpreted by the irrigation controller as a problem, while the second pulse rate may correspond to 100 gpm, which exceeds a threshold at the irrigation controller. Accordingly, without determining an actual flow rate, the flow sensor system 104 can communication information indicating a condition of water flow to the irrigation controller 102 taking advantage of the irrigation controller's capabilities to receive flow sensor data to allow the irrigation controller to determine whether to take action.

The sensor control circuit 120, in some embodiments, is further configured to determine the capabilities of the irrigation controller based on a coupling with the common line and/or the irrigation controller 102, through one or more activations of the flow notification, and/or queries communicated to the irrigation controller. Accordingly, the flow sensor system may have more than one mode of operation and/or operating systems. For example, the sensor control circuit 120 can initiate one or more communications to the irrigation controller, and based on a lack of response or type of response, the sensor control circuit can set the flow sensor system to operate in of the modes of operation. One mode of operation causes the flow sensor system to activate the common line switch 122 in attempts to interrupt irrigation. In another mode, the flow sensor system causes the flow notification to be activated causing a switch in the irrigation controller to be activated (e.g., when the flow indicator output 110 is coupled with a rain and/or flow sensor input of the irrigation controller). The irrigation controller may interrupt irrigation until a reset is received (e.g., through a user interface of the irrigation controller, through a communication from a central irrigation controller, through a wireless communication from a user's smart phone or other device, etc.), may temporarily interrupt for a predefined period of time and then again allow irrigation to determine if a flow problem continues. In one mode of operation, the sensor control circuit may communicate a mode request to the irrigation controller and receive flow capability reply such that the sensor control circuit causes pulses to be communicated to the irrigation controller corresponding to the detected flow within the irrigation pipe, which are to be utilized by the irrigation controller in determining whether one or more actions are to be taken in response to the pulses. Other modes may communicate the sensor data allowing the irrigation controller to evaluate the sensor data. Still other modes may communicate a notification of a determined state of flow. Such states may include one or more of low flow, expected flow, excess flow, no flow, or other such states.

Some embodiments utilize the capabilities of the irrigation controller to take one or more actions and/or to evaluate the sensor data in determining whether one or more actions are to be initiated. As introduced above, in some implementations the sensor control circuit 120 performs at least some processing of sensor data from the one or more sensor systems of the flow sensor system. Additionally or alternatively, the sensor data and/or communications corresponding to the sensor data can be communicated to the irrigation controller 102 to be processed by the irrigation controller. In some embodiments, the irrigation controller 102 is configured to receive the flow notification from the flow sensor system 104 and determine a water flow rate within the irrigation pipe 202 based on the flow notification. The irrigation controller may additionally or alternatively be configured to determine whether the determined water flow rate exceeds one or more flow rate thresholds. Again, for example, the acoustic data may include detected audio signatures that correspond to higher pitched sounds with increased volume or sound pressure corresponding to a flow rate that is greater than an expected audio signature corresponding to lower pitched sounds at reduced volumes or sound pressures, which may be interpreted as a flow rate in excess of expected flow rate thresholds. In some embodiments, one or more control circuits of the irrigation controller 102 are configured to identify, based on the acoustic data, a pattern in the acoustic data corresponding to one or more of a low water flow condition and an excessive water flow condition, wherein the low water flow condition corresponds to a lower than normal amount of water flow, and wherein the excessive water flow condition corresponds to a higher than normal amount of water flow. Based on one or more thresholds, the irrigation controller 102 may initiate an action when the determined water flow rate exceeds one or more of the flow rate thresholds. As another example, the temperature data may be interpreted by the irrigation controller as having a temperature difference 920 greater than a first temperature difference threshold for longer than a duration threshold after irrigation was terminated according to the irrigation schedule, which may be interpreted as a leak in a valve allowing water to continue to flow even after irrigation relative to the irrigation pipe being monitored is supposed to be turned off. Similarly, the irrigation controller may evaluate temperature data from the flow sensor system and detect a rate of change of temperate between the temperature of the pipe and the temperature of the surrounding and determine whether the rate of change of temperature is greater than a threshold rate indicating an excess flow (e.g., a broken sprinkler head releasing too much water).

Based on the evaluation of the sensor data relative to one or more predefined patterns and/or thresholds, the irrigation controller can determine whether one or more actions are to be initiated. Such actions can include terminating an irrigation schedule, terminating a portion of an irrigation schedule (e.g., specific to a particular zone were a problem is detected), generating one or more alarms or notifications, allowing irrigation to continue, and/or other such actions.

The flow sensor system 104 can be cooperated with any irrigation pipe 202 of the irrigation system. In many applications the flow sensor system 104 is cooperated with an irrigation pipe downstream of a valve (e.g., a main valve 106), which can allow the irrigation controller 102 to close that upstream valve in the event of an error condition. Further, more than one flow sensor system 104 can be utilized in a single irrigation system. Still further, different flow sensor systems 104 can be utilized with different zones of an irrigation system. This provides flow sensor data for different zones allowing greater precision control over various different parts of the irrigation system (e.g., zone by zone control).

As described above, in some embodiments, the flow sensor system 104 and/or irrigation controller 102 can operate in one or more learning modes to obtain sensor data and/or determine information corresponding to one or more states of flow within an irrigation pipe with which the sensor flow system is monitoring, which can be used for example in defining predefined thresholds, durations, and the like. The learning mode may be activated through a user interface (e.g., one or more buttons, touch screen, etc.), a predefined period of time following activation and/or powering up, a wireless triggering (e.g., from an irrigation controller, a user's smart phone or other portable device, a central irrigation controller, or other such device), other such activations, or combination of such activations. In some implementations one or more indicators, lights, audio instructions or the like can be activated providing information to the user implementing the learning mode. The flow sensor system, in some embodiments, can be configured to learn one or more flow states. For example, a first state may correspond to no flow; a second state may correspond to an expected flow when only a single operating mode is expected; a third state may correspond to a low flow state (e.g., when a drip line or other relatively low flow is operated); a fourth state may correspond to a sprinkler flow; a fifth state may correspond to a maximum flow state (which in some instances would correspond to an error state, such as by a user removing one or more sprinkler heads and activating irrigation); and the like. This learning mode can be utilized for the one or more acoustic sensors, the temperature sensors, or other sensors. Further, the learning mode may be implemented at different times for different sensors, or multiple sensors may operate simultaneously. In some embodiments, the sensor control circuit 120 is configured to operate in the learn state and determine one or more predefined acoustic patterns while in the learn state as a function of detected acoustic data, temperature data and/or other sensor data while in the learn state. Additionally or alternatively, flow state information, temperature patterns, and/or predefined acoustic patterns can be communicated to the flow sensor system 104 and/or the irrigation controller 102. In other embodiments, the irrigation controller 102 is operated in the learn mode and sensor data provided by the flow sensor system 104 is used by the irrigation controller to obtain and/or define the state information, temperature patterns, and/or predefined acoustic patterns, thresholds, and the like.

In some embodiments, the flow sensor system 104 includes a local power source, such as a long life battery, a rechargeable battery system (e.g., that can be charged by solar, wind, etc.), coupled to a separate external power source, can pull some or all of the power needed to operate from the irrigation controller, other sources, or combination of two or more of such sources. In some implementations, for example, the flow sensor system couples with the separate irrigation controller and harvests power by shorting a coupling with the irrigation controller (e.g., line to a sensor input switch) to draw a small current to charge a capacitor within the flow sensor system 104 that is subsequently used to operate the flow sensor system (e.g., repeatedly off for ten seconds, then on for one second). Similarly, communications with the irrigation controller may be achieved by shorting a two wire coupling with the irrigation controller, which can be detected by the irrigation controller. In other implementations, the irrigation controller includes a power line that supplies power (e.g., 24V AC) to the flow sensor system, and may control when power is supplied to the flow sensor system.

The flow sensor system 104 may include one or more alarms that can be activated in response to conditions exceeding one or more thresholds. The alarm may be audio, visual or a communication. For example, the flow sensor system 104 may communicate an alarm notification to the irrigation controller that in turn generates an alarm notification. In other instances, the flow sensor system may wirelessly communicate an alarm notification, such as communicating the alarm notification a user's smart phone, tablet, etc. Similarly, the irrigation controller may additionally or alternatively communicate an alarm notification.

FIG. 10 illustrates a simplified flow diagram of an exemplary process 1000 of controlling irrigation based on water flow, in accordance with some embodiments. In step 1002 detected acoustic data is obtained from one or more acoustic sensors 310 relative to water flow within an irrigation pipe 202 that is configured to allow water to flow through an irrigation system 100. In some implementations, a single acoustic sensor is positioned adjacent to or abutting the irrigation pipe. In other instances, multiple acoustic sensors may be positioned spaced about a circumference and/or spaced along one or more segments of the length of the irrigation pipe. Each of the acoustic sensors 310 couples with one of one or more sensor control circuits 120 and/or a transceiver to communicate the sensor data to a separate irrigation controller. In some embodiments, a sensor control circuit 120 may couple with multiple different acoustic sensors positioned relative to different irrigation pipes. The sensor control circuit 120, in some implementations, controls and/or activates the acoustic sensor to initiate the detection of acoustic data that can be considered in evaluating flow within the irrigation pipe.

In step 1004, the acoustic data is evaluated to identify based on the acoustic data when a change in the detected acoustic data is consistent with one or more predefined acoustic patterns corresponding to a predefined flow rate. Again, multiple different predefined acoustic patterns may be learned and/or provided to the flow sensor system 104 and/or irrigation controller 102 (e.g., from a manufacturer, added by a user prior to installation, etc.). In step 1006, a flow notification is activated from the flow indicator output 110 when the change in the detected acoustic data is consistent with the one or more predefined acoustic patterns. As described above, the flow indicator output 110 is configured to couple with the separate irrigation controller 102, which is configured to control the irrigation valves 106 of the irrigation system 100 in accordance with one or more defined irrigation schedules.

Some embodiments, in activating the flow notification, wirelessly communicate the flow notification to the irrigation controller 102. This wireless communication may be via a low power, relatively limited range wireless communication (e.g., Wi-Fi, Bluetooth, Bluetooth low energy (BLE), ZigBee, etc.), radio frequency (RF), cellular, other such wireless communication methods, or combination of two or more of such wireless communication techniques. Additionally or alternatively, some embodiments in activating the flow notification open a common line switch 122 coupled with a common line 112 from the irrigation controller to cause an interruption of the irrigation schedule being implemented by the irrigation controller 102. In some applications, the opening of the common line 112 is not detected by the irrigation controller, and the irrigation controller continues to operate. In other embodiments, the irrigation controller may detect the opening of the common line and halt the continued implementation of the irrigation schedule. The opening of the common line may be maintained until a user manually resets or overrides the opening (e.g., in response to correcting a flow problem). Additionally or alternatively, the sensor control circuit 120 and/or the irrigation controller may maintain the common line open and/or interrupt irrigation for a threshold duration, and then reconnect the common line. The threshold duration may be predefined (e.g., a common runtime for a single zone of multiple zones), set by a user (e.g., through the irrigation controller and/or an interface of the flow sensor system 104, such as toggling between two or more predefined sets of durations, setting the duration through a display, etc.), or the like. This predefined duration allows subsequent irrigation schedules and/or irrigation over one or more other zones to occur unless a flow issue is again detected. Similarly, the threshold duration allows irrigation to resume once a flow problem has been corrected without resetting or communicating with the flow sensor system.

In some embodiments, the change in the acoustic data is compared with a set of multiple predefined acoustic patterns, and an estimated first flow rate of the water within the irrigation pipe is determined based on the change in acoustic data being consistent with the at least one of the predefined acoustic patterns of the set of the multiple predefined acoustic patterns. Again, these predefined acoustic patterns may be learned or predefined. Some embodiments attempt to mimics paddle flow sensor. In some instances, the activation the flow notification comprises causing a pattern of pulses to be communicated to the irrigation controller 102 with the pattern of pulses being indicative of an estimated flow rate, which may be determined based on the acoustic data, temperature data and/or other information. These patterns of pulses can be interpreted by some kinds of irrigation controllers as corresponding to the estimated flow rate allowing the irrigation controller to evaluate the estimated flow and take one or more action (e.g., displaying and/or communicating the estimated flow to a user, generating an interrupt condition for one or more zones, causing an alarm to be activated or notification to be communicated to a user, logging data, estimating water usage, adjusting runtimes, other such actions, or combination of two or more of such actions). Different patterns of pulses can be communicated depending on the estimated flow. Further, the irrigation controller 102 is configured, in some implementations, to receive the flow notification and determine, at the irrigation controller, a water flow rate within the irrigation pipe based on the flow notification. Using the determined water flow rate, the irrigation controller can determine whether the determined water flow rate exceeds one or more flow rate thresholds, and initiate an action when the determined water flow rate exceeds a flow rate threshold.

In some embodiments, as described above, the flow sensor system 104 and/or the sensor control circuit 120 can be configured to operate in a learn state to determine one or more states, patterns, conditions or the like. For example, the sensor control circuit can be configured to operate in the learn state to obtain acoustic data that can be used to determine or define one or more predefined acoustic patterns as a function of detected acoustic data while the sensor control circuit is operating in the learn state. Similarly, the sensor control circuit can be configured to learn one or more temperature patterns, changes in temperature patterns, one or more durations of temperature changes, and/or other such conditions. Some embodiments, in addition to the acoustic data, receive pipe temperature data from one or more pipe temperature sensors 314 secured with the housing 304 of the irrigation water flow sensor system 104 proximate one of one or more pipe nesting surfaces 306. Again, the pipe nesting surface is configured to be positioned adjacent with an exterior surface 302 of the irrigation pipe 202. Further, in some instances environment temperature data can additionally be received from one or more environment temperature sensors 315 secured proximate one of one or more exterior housing surfaces 308 of the housing. The temperature data can be evaluated to detect an occurrence of a threshold temperature difference 922 between the pipe temperature data and the environment temperature data, and a flow notification can be activated from the flow indicator output 110 based on the detected threshold temperature difference occurring between the pipe temperature data 902 and the environment temperature data 904.

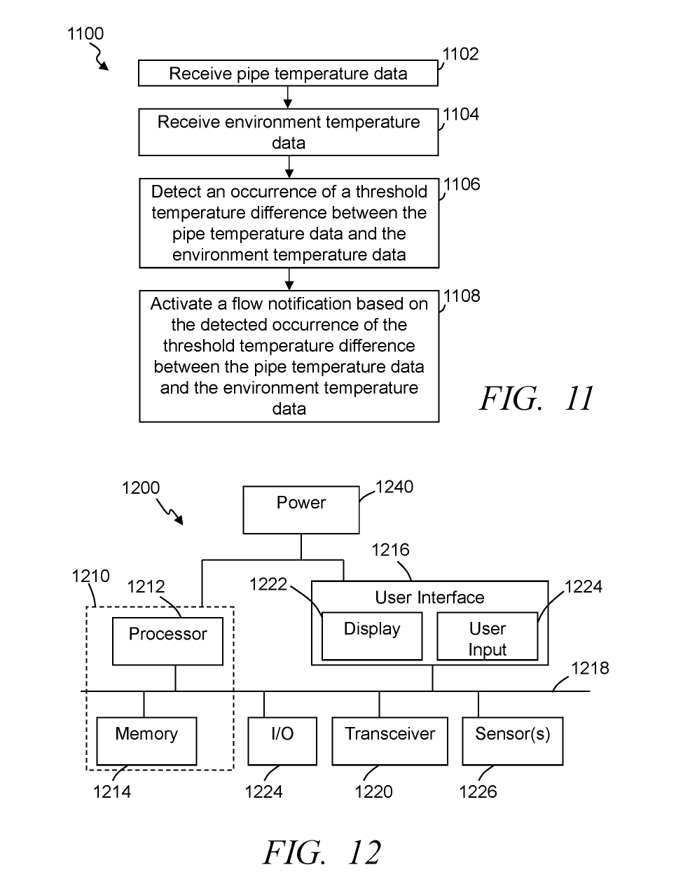

FIG. 11 illustrates a simplified flow diagram of an exemplary process 1100 of controlling irrigation based on water flow, in accordance with some embodiments. In step 1102, pipe temperature data is received from at least a pipe temperature sensor 314 secured with the housing 304 of an irrigation water flow sensor system 104. Typically, the pipe temperature sensor is positioned with the housing 304 is such a way as to be proximate the pipe nesting surface 306 of the housing 304. The pipe nesting surface is configured to be positioned adjacent with and/or abutting an exterior surface 302 of an irrigation pipe 202. In some embodiments, environment temperature data is also received from an environment temperature sensor 315 secured with the housing 304 of the flow sensor system. In some applications, the environment temperature sensor 315 is positioned proximate an exterior housing surface 308 of the housing.

In step 1104, the temperature data is evaluated to detect an occurrence of a threshold temperature difference. In some applications, the temperature threshold difference is a difference between a change in pipe temperature greater than a threshold, which further may be limited to the threshold temperature change over a limited threshold duration. Additionally or alternatively, the detection of the occurrence of the threshold temperature difference is determined between the pipe temperature data and the environment temperature data. In step 1106, one or more flow notifications are activated from the flow indicator output 110 of the irrigation water flow sensor system 104 based on the detected occurrence of the threshold temperature difference, such as between the pipe temperature data and the environment temperature data.

As introduced above, some embodiments in activating the flow notification wirelessly communicate the flow notification to the irrigation controller 102. In other applications, the activation of the flow notification comprises opening a common line switch 122 coupled with a common line 112 of the separate irrigation controller 102 and interrupting an irrigation schedule being implemented by the irrigation controller. In some embodiments, the temperature data is evaluated to determine a rate of change of temperatures between the pipe temperature data and the environment temperature data, and a corresponding flow rate of the water within the irrigation pipe can be identified based on the determined rate of change of temperatures. Some embodiments are provided with predefined relationships between rates of change of temperature and corresponding flow rates. Further, in some instances, the rates of change of temperature may be dependent on initial starting temperatures, environmental temperatures, expected temperatures of water from a water source and/or other such factors. In some embodiments, the relationships between rates of change of temperature and corresponding flow rates may be learned over time (e.g., rates of change of temperature correlated with known flow rates based on known activated valves). Further, in some applications, the determination of the flow rate can include identifying a flow of less than a nominal threshold based on the difference in temperatures between the pipe temperature data and the environment temperature data returning to within a temperature threshold difference. In some instances, for example, the sensor control circuit 120 and/or the irrigation controller 102 may detect the temperature difference between the pipe temperature data and the environment temperature data returning to within a temperature threshold difference following a termination of active flow within the irrigation pipe.

Again, some embodiments utilize one or more learn modes or states to acquire threshold conditions, to define predefined parameters and/or signatures, and the like. In some embodiments, the sensor control circuit 120 of the irrigation water flow sensor system 104 can be operated in a learn state, and one or more threshold temperature differences, threshold periods of time, threshold correlations between acoustic signatures and/or other such thresholds can be determined while in the learn state. For example, the nominal temperature threshold may be determined as a function of the detected temperature change between the pipe temperature data and the environment temperature data while in the learn state. Similarly, in some embodiments the sensor control circuit and/or irrigation controller, while in the learn state, determine one or more threshold temperature differences 922 and/or threshold rates of change of temperatures while in the learn state as a function of the detected temperature change between the pipe temperature data and the environment temperature data while in the learn state. Again, some embodiments in addition to temperature data additionally obtain detected acoustic data relative to the water within the irrigation pipe, identify based on the acoustic data when a change in detected acoustic data is consistent with a predefined acoustic pattern corresponding to a predefined flow rate, and activate a flow notification from the flow indicator output when the change in the detected acoustic data is consistent with the predefined acoustic pattern.

Further, the circuits, circuitry, systems, devices, processes, methods, techniques, functionality, services, sources and the like described herein may be utilized, implemented and/or run on many different types of devices and/or systems. FIG. 12 illustrates an exemplary system 1200 that may be used for implementing any of the components, circuits, circuitry, systems, functionality, apparatuses, processes, or devices of the irrigation system 100, and/or other above or below mentioned systems or devices, or parts of such circuits, circuitry, functionality, systems, apparatuses, processes, or devices. For example, the system 1200 may be used to implement some or all of the irrigation controller 102, the flow sensor system 104, the sensor control circuit 120, a control circuit of the irrigation controller, and/or other such components, circuitry, functionality and/or devices. However, the use of the system 1200 or any portion thereof is certainly not required.

By way of example, the system 1200 may comprise a control circuit or processor module 1212, memory 1214, and one or more communication links, paths, buses or the like 1218. Some embodiments may include one or more user interfaces 1216, and/or one or more internal and/or external power sources or supplies 1240. The control circuit 1212 can be implemented through one or more processors, microprocessors, central processing unit, logic, local digital storage, firmware, software, and/or other control hardware and/or software, and may be used to execute or assist in executing the steps of the processes, methods, functionality and techniques described herein, and control various communications, decisions, programs, content, listings, services, interfaces, logging, reporting, etc. Further, in some embodiments, the control circuit 1212 can be part of control circuitry and/or a control system 1210, which may be implemented through one or more processors with access to one or more memory 1214 that can store instructions, code and the like that is implemented by the control circuit and/or processors to implement intended functionality. In some applications, the control circuit and/or memory may be access over and/or distributed over a communications network (e.g., LAN, WAN, Internet) providing distributed and/or redundant processing and functionality.

The user interface 1216 can allow a user to interact with the system 1200 and receive information through the system. In some instances, the user interface 1216 includes a display 1222 and/or one or more user inputs 1224, such as buttons, touch screen, track ball, keyboard, mouse, etc., which can be part of or wired or wirelessly coupled with the system 1200. Typically, the system 1200 further includes one or more communication interfaces, ports, transceivers 1220 and the like allowing the system 1200 to communicate over a communication bus, a distributed computer and/or communication network 610 (e.g., a local area network (LAN), the Internet, wide area network (WAN), etc.), communication link 1218, other networks or communication channels with other devices and/or other such communications or combination of two or more of such communication methods. Further the transceiver 1220 can be configured for wired, wireless, optical, fiber optical cable, satellite, or other such communication configurations or combinations of two or more of such communications. Some embodiments include one or more input/output (I/O) ports 1234 that allow one or more devices to couple with the system 1200. The I/O ports can be substantially any relevant port or combinations of ports, such as but not limited to USB, Ethernet, or other such ports. The I/O interface 1234 can be configured to allow wired and/or wireless communication coupling to external components. For example, the I/O interface can provide wired communication and/or wireless communication (e.g., Wi-Fi, Bluetooth, cellular, RF, and/or other such wireless communication), and in some instances may include any known wired and/or wireless interfacing device, circuit and/or connecting device, such as but not limited to one or more transmitters, receivers, transceivers, or combination of two or more of such devices.

In some embodiments, the system may include one or more sensors 1226. The sensors can include substantially any relevant sensor, such as acoustic or sound sensors, temperature sensors, rain sensors, and other such sensors. The foregoing examples are intended to be illustrative and are not intended to convey an exhaustive listing of all possible sensors. Instead, it will be understood that these teachings will accommodate sensing any of a wide variety of circumstances in a given application setting.

The system 1200 comprises an example of a control and/or processor-based system with the control circuit 1212. Again, the control circuit 1212 can be implemented through one or more processors, controllers, central processing units, logic, software and the like. Further, in some implementations the control circuit 1212 may provide multiprocessor functionality.

The memory 1214, which can be accessed by the control circuit 1212, typically includes one or more processor readable and/or computer readable media accessed by at least the control circuit 1212, and can include volatile and/or nonvolatile media, such as RAM, ROM, EEPROM, flash memory and/or other memory technology. Further, the memory 1214 is shown as internal to the control system 1210; however, the memory 1214 can be internal, external or a combination of internal and external memory. Similarly, some or all of the memory 1214 can be internal, external or a combination of internal and external memory of the control circuit 1212. The external memory can be substantially any relevant memory such as, but not limited to, solid-state storage devices or drives, hard drive, one or more of universal serial bus (USB) stick or drive, flash memory secure digital (SD) card, other memory cards, and other such memory or combinations of two or more of such memory. The memory 1214 can store code, software, executables, scripts, data, patterns, thresholds, lists, programs, log or history data, and the like. While FIG. 12 illustrates the various components being coupled together via a bus, it is understood that the various components may actually be coupled to the control circuit and/or one or more other components directly.

In some embodiments, irrigation systems and corresponding methods performed by the systems, comprise: an irrigation water flow sensor system comprising: a housing comprising a pipe nesting surface, wherein the pipe nesting surface is configured to be positioned adjacent with an exterior surface of an irrigation pipe that is configured to allow water to flow through an irrigation system; an acoustic sensor secured with the housing proximate the pipe nesting surface; a sensor control circuit communicatively coupled with the acoustic sensor and configured to receive acoustic data, and identify based on the acoustic data when a change in detected acoustic data is consistent with a first predefined acoustic pattern; and a flow indicator output communicatively coupled with the sensor control circuit and configured to further coupled with a separate irrigation controller that is configured to control irrigation valves of the irrigation system in accordance with a defined irrigation schedule, and wherein the sensor control circuit is configured to activate a first flow notification from the flow indicator output when the change in detected acoustic data is consistent with the first predefined acoustic pattern.

Further some embodiments provide methods of controlling irrigation based on water flow, comprising: non-invasively detecting, from external to an irrigation pipe, acoustic data relative to water flow within an irrigation pipe configured to allow water to flow through an irrigation system; identifying based on the acoustic data when a change in detected acoustic data is consistent with a first predefined acoustic pattern corresponding to a predefined flow rate; and activating a first flow notification from a flow indicator output, which is configured to couple with a separate irrigation controller that is configured to control irrigation valves of the irrigation system in accordance with a defined irrigation schedule, when the change in the detected acoustic data is consistent with the first predefined acoustic pattern.

In some embodiments, water flow controlled irrigation systems are provided that comprise: a housing comprising a pipe nesting surface and at least one exterior housing surface, wherein the pipe nesting surface is configured to be positioned adjacent with an exterior surface of an irrigation pipe that is configured to allow water to flow as part of an irrigation system; a pipe temperature sensor secured with the housing proximate the pipe nesting surface, and an environment temperature sensor secured with the housing proximate the at least one exterior housing surface; a sensor control circuit communicatively coupled with the pipe temperature sensor and the environment temperature sensor and configured to receive pipe temperature data from the pipe temperature sensor and environment temperature data from the environment temperature sensor, and further configured to detect an occurrence of a threshold temperature difference between the pipe temperature data and the environment temperature data; a flow indicator output communicatively coupled with the sensor control circuit and configured to further couple with a separate irrigation controller that is configured to control irrigation valves of the irrigation system in accordance with a defined irrigation schedule, and wherein the sensor control circuit is configured to activate a first flow notification from the flow indicator output based on the detected occurrence of the threshold temperature difference between the pipe temperature data and the environment temperature data.

Further embodiments provide methods of controlling irrigation based on water flow, comprising: non-invasively detecting, from external to an irrigation pipe, pipe temperature data from a pipe temperature sensor of an irrigation water flow sensor system positioned adjacent with an exterior surface of an irrigation pipe, wherein the irrigation water flow sensor system is separate from an irrigation controller configured to control irrigation valves of an irrigation system in accordance with a defined irrigation schedule; receiving environment temperature data from an environment temperature sensor; detecting an occurrence of a threshold temperature difference between the pipe temperature data and the environment temperature data; and activating a first flow notification from a flow indicator output of the irrigation water flow sensor system based on the detected occurrence of the threshold temperature difference between the pipe temperature data and the environment temperature data.

Some embodiments provide methods of controlling irrigation based on water flow, comprising: receiving pipe temperature data from a pipe temperature sensor secured with a housing of an irrigation water flow sensor system and proximate a pipe nesting surface of the housing, wherein the pipe nesting surface is configured to be positioned adjacent with an exterior surface of an irrigation pipe, wherein the irrigation water flow sensor system is separate from an irrigation controller configured to control irrigation valves of an irrigation system in accordance with a defined irrigation schedule; receiving environment temperature data from an environment temperature sensor secured proximate an exterior housing surface of the housing; detecting an occurrence of a threshold temperature difference between the pipe temperature data and the environment temperature data; and activating a first flow notification from a flow indicator output of the irrigation water flow sensor system based on the detected occurrence of the threshold temperature difference between the pipe temperature data and the environment temperature data.

Some embodiments provide a non-invasive water flow sensor for use in an irrigation system, comprising: a housing comprising a pipe nesting surface configured to be positioned adjacent to an exterior surface of an irrigation pipe that is configured to allow water to flow therethrough; an acoustic sensor coupled to the housing proximate the pipe nesting surface and configured to receive acoustic data; a control circuit communicatively coupled with the acoustic sensor and configured to: receive acoustic data from the acoustic sensor; and identify, based on the acoustic data, a pattern in the acoustic data corresponding to one or more of a low water flow condition and an excessive water flow condition, wherein the low water flow condition corresponds to a lower than normal amount of water flow, and wherein the excessive water flow condition corresponds to a higher than normal amount of water flow.

Further, some embodiments provide a non-invasive water flow sensor for use in an irrigation system, comprising: a housing comprising a pipe nesting surface configured to be positioned adjacent to an exterior surface of an irrigation pipe that is configured to allow water to flow therethrough; a pipe temperature sensor secured with the housing proximate the pipe nesting surface; an environment temperature sensor secured with the housing proximate an exterior housing surface of the housing; a control circuit communicatively coupled with the acoustic sensor and configured to: receive pipe temperature data from the pipe temperature sensor and environment temperature data from the environment temperature sensor; identify, based on a temperature difference between the pipe temperature data and the environment temperature data, a threshold temperature difference corresponding to at least one of the low water flow condition and the excessive water flow condition, wherein the low water flow condition corresponds to a lower than normal amount of water flow, and wherein the excessive water flow condition corresponds to a higher than normal amount of water flow.

Further, some embodiments provide water flow controlled irrigation systems that comprise: a housing comprising a pipe nesting surface and at least one exterior housing surface, wherein the pipe nesting surface is configured to be positioned adjacent with an exterior surface of an irrigation pipe that is configured to allow water to flow therethrough as part of an irrigation system; a pipe temperature sensor secured with the housing proximate the pipe nesting surface; an environment temperature sensor secured with the housing proximate the at least one exterior housing surface; a sensor control circuit communicatively coupled with the pipe temperature sensor and the environment temperature sensor and configured to receive pipe temperature data from the pipe temperature sensor and environment temperature data from the environment temperature sensor, and further configured to detect an occurrence of a threshold temperature difference between the pipe temperature data and the environment temperature data; and a flow indicator output communicatively coupled with the sensor control circuit and configured to further couple with a separate irrigation controller that is configured to control irrigation valves of the irrigation system in accordance with a defined irrigation schedule, and wherein the sensor control circuit is configured to activate a first flow notification from the flow indicator output based on the detected occurrence of the threshold temperature difference between the pipe temperature data and the environment temperature data. In some implementations, the flow indicator output comprises a wireless transceiver configured to wirelessly communicate the first flow notification to the irrigation controller. Additionally or alternatively, in some implementations the flow indicator output comprises a common line switch configured to couple with a common line of the irrigation controller, wherein the sensor control circuit is configured to open the common line switch to activate the first flow notification and interrupt the irrigation schedule being implemented by the irrigation controller.

In some embodiments, the sensor control circuit is configured to determine a rate of change of temperatures between the pipe temperature data and the environment temperature data, and identify a first flow rate of the water within the irrigation pipe based on the determined rate of change of temperatures. The sensor control circuit, in some applications, is configured to identify a flow of less than a nominal threshold based on the difference in temperatures between the pipe temperature data and the environment temperature data returning to within a temperature threshold difference. In some embodiments, the sensor control circuit is configured to operate in a learn state and determine the threshold temperature difference while in the learn state as a function of the detected temperature change between the pipe temperature data and the environment temperature data while in the learn state.

The water flow controlled irrigation system can, in some embodiments, further comprise: an acoustic sensor secured with the housing proximate the pipe nesting surface and communicatively coupled with the sensor control circuit, wherein the sensor control circuit is configured to: receive acoustic data, and identify based on the acoustic data when a change in detected acoustic data is consistent with a first predefined acoustic pattern; and activate a second flow notification from the flow indicator output when the change in detected acoustic data is consistent with the first predefined acoustic pattern.

Some embodiments provide methods of controlling irrigation based on water flow, comprising: non-invasively detecting, from external to an irrigation pipe, pipe temperature data from a pipe temperature sensor of an irrigation water flow sensor system positioned adjacent with an exterior surface of the irrigation pipe, wherein the irrigation water flow sensor system is separate from an irrigation controller configured to control irrigation valves of an irrigation system in accordance with a defined irrigation schedule; receiving environment temperature data from an environment temperature sensor; detecting an occurrence of a threshold temperature difference between the pipe temperature data and the environment temperature data; and activating a first flow notification from a flow indicator output of the irrigation water flow sensor system based on the detected occurrence of the threshold temperature difference between the pipe temperature data and the environment temperature data. The activating the first flow notification can comprise wirelessly communicating the first flow notification to the irrigation controller. Additionally or alternatively, the activating the first flow notification may comprise opening a common line switch coupled with a common line of the separate irrigation controller and interrupting an irrigation schedule being implemented by the irrigation controller.

In some implementations, the method of controlling irrigation can further comprise: determining a rate of change of temperatures between the pipe temperature data and the environment temperature data; and identifying a first flow rate of the water within the irrigation pipe based on the determined rate of change of temperatures. Some embodiments further identify a flow of less than a nominal threshold based on the difference in temperatures between the pipe temperature data and the environment temperature data returning to within a temperature threshold difference. Some embodiments further comprise: operating a sensor control circuit of the irrigation water flow sensor system in a learn state; and determining the threshold temperature difference while in the learn state as a function of the detected temperature change between the pipe temperature data and the environment temperature data while in the learn state. Still further, some embodiments may further comprise: obtaining detected acoustic data relative to the water within the irrigation pipe; identifying based on the acoustic data when a change in detected acoustic data is consistent with a first predefined acoustic pattern corresponding to a predefined flow rate; and activating a second flow notification from the flow indicator output when the change in the detected acoustic data is consistent with the first predefined acoustic pattern.

Some embodiments provide non-invasive water flow sensors for use in an irrigation system. These non-invasive water flow sensors may comprise: a housing comprising a pipe nesting surface configured to be positioned adjacent to an exterior surface of an irrigation pipe that is configured to allow water to flow therethrough; an acoustic sensor coupled to the housing proximate the pipe nesting surface and configured to receive acoustic data; a sensor control circuit communicatively coupled with the acoustic sensor and configured to: receive acoustic data from the acoustic sensor; and identify, based on the acoustic data, a pattern in the acoustic data corresponding to one or more of a low water flow condition and an excessive water flow condition, wherein the low water flow condition corresponds to a lower than normal amount of water flow, and wherein the excessive water flow condition corresponds to a higher than normal amount of water flow. In some instances, a water flow sensor may further comprise: a pipe temperature sensor secured with the housing proximate the pipe nesting surface; an environment temperature sensor secured with the housing proximate an exterior housing surface of the housing; the sensor control circuit communicatively coupled with the pipe temperature sensor and the environment temperature sensor and configured to: receive pipe temperature data from the pipe temperature sensor and environment temperature data from the environment temperature sensor; identify, based on a temperature difference between the pipe temperature data and the environment temperature data, one of the low water flow condition and the excessive water flow condition. The sensor control circuit may further be configured to compare a change in the acoustic data with a set of multiple predefined acoustic patterns, and determine an estimated flow rate of the water within the irrigation pipe based on the change in acoustic data being consistent with a first predefined acoustic pattern of the set of the multiple predefined acoustic patterns. Similarly, the sensor control circuit may be configured to operate in a learn state and determine the first predefined acoustic pattern while in the learn state as a function of detected acoustic data while in the learn state. In some embodiments, the water flow sensor further comprises: a flow indicator output communicatively coupled with the sensor control circuit and configured to further couple with a separate irrigation controller that is configured to control irrigation valves of the irrigation system in accordance with an irrigation schedule, and wherein the sensor control circuit is configured to activate a first flow notification from the flow indicator output corresponding one of the low water flow condition and the excessive water flow condition.

Some embodiments provide non-invasive water flow sensors for use in an irrigation system, comprising: a housing comprising a pipe nesting surface configured to be positioned adjacent to an exterior surface of an irrigation pipe that is configured to allow water to flow therethrough; a pipe temperature sensor secured with the housing proximate the pipe nesting surface; an environment temperature sensor secured with the housing proximate an exterior housing surface of the housing; a sensor control circuit communicatively coupled with the pipe temperature sensor and the environment temperature sensor and configured to: receive pipe temperature data from the pipe temperature sensor and environment temperature data from the environment temperature sensor; identify, based on a temperature difference between the pipe temperature data and the environment temperature data, a threshold temperature difference corresponding to at least one of the low water flow condition and the excessive water flow condition, wherein the low water flow condition corresponds to a lower than normal amount of water flow, and wherein the excessive water flow condition corresponds to a higher than normal amount of water flow.

Those skilled in the art will recognize that a wide variety of other modifications, alterations, and combinations can also be made with respect to the above described embodiments without departing from the scope of the invention, and that such modifications, alterations, and combinations are to be viewed as being within the ambit of the inventive concept.

What is claimed is:

1. A water flow controlled irrigation system, comprising:
an irrigation water flow sensor system comprising:
a housing comprising a pipe nesting surface, wherein the pipe nesting surface is configured to be positioned adjacent with an exterior surface of an irrigation pipe that is configured to allow water to flow therethrough;
an acoustic sensor secured with the housing proximate the pipe nesting surface;
a sensor control circuit communicatively coupled with the acoustic sensor and configured to receive acoustic data, and identify based on the acoustic data when a change in detected acoustic data is consistent with a first predefined acoustic pattern; and
a flow indicator output communicatively coupled with the sensor control circuit and configured to further couple with a separate irrigation controller that is configured to control irrigation valves of the irrigation system in accordance with an irrigation schedule, and wherein the sensor control circuit is configured to activate a first flow notification from the flow indicator output when the change in detected acoustic data is consistent with the first predefined acoustic pattern.

2. The water flow controlled irrigation system of claim 1, wherein the flow indicator output comprises a wireless transceiver configured to wirelessly communicate the first flow notification to the separate irrigation controller.

3. The water flow controlled irrigation system of claim 1, wherein the flow indicator output comprises a common line switch configured to couple with a common line of the irrigation controller, wherein the sensor control circuit is configured to open the common line switch to activate the first flow notification and interrupt the irrigation schedule being implemented by the irrigation controller.

4. The water flow controlled irrigation system of claim 1, wherein the flow indicator output comprises a switch configured to couple with a sensor input of the separate irrigation controller, wherein the sensor control circuit is configured to change a state of the switch to activate the first flow notification to be detected by the irrigation controller.

5. The water flow controlled irrigation system of claim 1, wherein the sensor control circuit is configured to compare the change in the acoustic data with a set of multiple predefined acoustic patterns including the first predefined acoustic pattern, and determine an estimated first flow rate of the water within the irrigation pipe based on the change in acoustic data being consistent with the first predefined acoustic pattern of the set of the multiple predefined acoustic patterns.

6. The water flow controlled irrigation system of claim 5, wherein the sensor control circuit in activating the first flow notification is configured to cause a first pattern of pulses to be communicated to the irrigation controller indicative of the estimated first flow rate and configured to be interpreted by the irrigation controller as corresponding to the estimated first flow rate.

7. The water flow controlled irrigation system of claim 4, wherein the sensor control circuit in activating the first flow notification is configured to output one of at least two values based on the estimated first flow rate comprising a first output value representative of an excessive water flow condition and a second output value representative of a low water flow condition, wherein the low water flow condition corresponds to a lower than normal amount of water flow, and wherein the excessive water flow condition corresponds to a higher than normal amount of water flow.

8. The water flow controlled irrigation system of claim 1, wherein the sensor control circuit is configured to operate in a learn state and determine the first predefined acoustic pattern while in the learn state as a function of detected acoustic data while in the learn state.

9. The water flow controlled irrigation system of claim 1, further comprising:
a pipe temperature sensor secured with the housing proximate the pipe nesting surface;
an environment temperature sensor secured with the housing proximate an exterior housing surface of the housing;
the sensor control circuit communicatively coupled with the pipe temperature sensor and the environment temperature sensor and configured to:
receive pipe temperature data from the pipe temperature sensor and environment temperature data from the environment temperature sensor;
detect an occurrence of a threshold temperature difference between the pipe temperature data and the environment temperature data; and
activate a second flow notification from the flow indicator output based on the detected threshold temperature difference occurring between the pipe temperature data and the environment temperature data.

10. The water flow controlled irrigation system of claim 1, further comprising:
the irrigation controller configured to receive the first flow notification, determine a water flow rate within the irrigation pipe based on the first flow notification, determine whether the determined water flow rate exceeds a first flow rate threshold, and initiate an action when the determined water flow rate exceeds the first flow rate threshold.

11. A method of controlling irrigation based on water flow, comprising:
non-invasively detecting, from external to an irrigation pipe, acoustic data relative to water flow within the irrigation pipe configured to allow water to flow through an irrigation system;
identifying based on the acoustic data when a change in detected acoustic data is consistent with a first predefined acoustic pattern corresponding to a predefined flow rate; and
activating a first flow notification from a flow indicator output, which is configured to couple with a separate irrigation controller that is configured to control irrigation valves of the irrigation system in accordance with a defined irrigation schedule, when the change in the detected acoustic data is consistent with the first predefined acoustic pattern.

12. The method of claim 11, wherein the activating the first flow notification comprises wirelessly communicating the first flow notification to the irrigation controller.

13. The method of claim 11, wherein the activating the first flow notification comprises opening a common line switch coupled with a common line of the irrigation controller and interrupting the irrigation schedule being implemented by the irrigation controller.

14. The method of claim 11, wherein activating the first flow notification comprises causing a change in state of a switch configured to couple with a sensor input of the separate irrigation controller wherein the change is state of the switch is to be detected by the irrigation controller and be utilized by the irrigation controller in interrupting the irrigation schedule being implemented by the irrigation controller.

15. The method of claim 11, further comprising:
comparing the change in the acoustic data with a set of multiple predefined acoustic patterns, including the first predefined acoustic pattern; and
determining an estimated first flow rate of the water within the irrigation pipe based on the change in acoustic data being consistent with the first predefined acoustic pattern of the set of the multiple predefined acoustic patterns.

16. The method of claim 15, wherein the activating the first flow notification comprises causing a first pattern of pulses to be communicated to the irrigation controller indicative of the estimated first flow rate and configured to be interpreted by the irrigation controller as corresponding to the estimated first flow rate.

17. The method of claim 15, wherein the activating the first flow notification comprises causing an output of one of a first output value representative of an excessive water flow condition and a second output value representative of a low water flow condition, wherein the low water flow condition corresponds to a lower than normal amount of water flow, and wherein the excessive water flow condition corresponds to a higher than normal amount of water flow.

18. The method of claim 11, further comprising:
operating a sensor control circuit in a learn state and determining the first predefined acoustic pattern as a function of detected acoustic data while the sensor control circuit is operating in the learn state.

19. The method claim 11, further comprising:
non-invasively detecting, from external to the irrigation pipe, pipe temperature data from a pipe temperature sensor positioned adjacent with an exterior surface of the irrigation pipe;
receiving environment temperature data from an environment temperature sensor;
detecting an occurrence of a threshold temperature difference between the pipe temperature data and the environment temperature data; and
activating a second flow notification from the flow indicator output based on the detected threshold temperature difference occurring between the pipe temperature data and the environment temperature data.

20. The method of claim 11, further comprising:
receiving, at the irrigation controller, the first flow notification;
determining, at the irrigation controller, a water flow rate within the irrigation pipe based on the first flow notification;
determining, at the irrigation controller, whether the determined water flow rate exceeds a first flow rate threshold; and
initiating an action when the determined water flow rate exceeds the first flow rate threshold.

21. A water flow controlled irrigation system, comprising:
a housing comprising a pipe nesting surface and at least one exterior housing surface, wherein the pipe nesting surface is configured to be positioned adjacent with an exterior surface of an irrigation pipe that is configured to allow water to flow therethrough as part of an irrigation system;
a pipe temperature sensor secured with the housing proximate the pipe nesting surface;
an environment temperature sensor secured with the housing proximate the at least one exterior housing surface;
a sensor control circuit communicatively coupled with the pipe temperature sensor and the environment temperature sensor and configured to receive pipe temperature data from the pipe temperature sensor and environment temperature data from the environment temperature sensor, and further configured to detect an occurrence of a threshold temperature difference between the pipe temperature data and the environment temperature data;
a flow indicator output communicatively coupled with the sensor control circuit and configured to further couple with a separate irrigation controller that is configured to control irrigation valves of the irrigation system in accordance with a defined irrigation schedule, and wherein the sensor control circuit is configured to activate a first flow notification from the flow indicator output based on the detected occurrence of the threshold temperature difference between the pipe temperature data and the environment temperature data.
